(19) United States
(12) Patent Application Publication
(10) Pub. No.: US 2020/0286408 A1
(43) Pub. Date: Sep. 10, 2020

(54) COLOR-CODING DEVICE AND METHOD

(71) Applicant: Dakoda R. Hudak, Floodwood, MN (US)

(72) Inventor: Dakoda R. Hudak, Floodwood, MN (US)

(21) Appl. No.: 16/813,560

(22) Filed: Mar. 9, 2020

Related U.S. Application Data
(60) Provisional application No. 62/829,518, filed on Apr. 4, 2019.
(60) Provisional application No. 62/827,123, filed on Mar. 31, 2019.
(60) Provisional application No. 62/821,296, filed on Mar. 20, 2019.
(60) Provisional application No. 62/815,519, filed on Mar. 8, 2019.

(51) Int. Cl. G09F 3/10

(52) U.S. Cl. CPC G09F 3/10; G09F 2003/0276

(57) ABSTRACT

An apparatus and a corresponding method that includes providing a color-code device having a first pre-cut piece of tape having an adhesive surface covered by a release liner. wherein the first pre-cut piece of tape has a starting end and a finish end, and wherein the finish end has a diagonal edge at an acute angle to a lengthwise edge of the piece of tape; removing a first piece, of the release liner; and beginning with the start end, wrapping the first piece of tape around a communications cable while removing a remaining piece of the release liner. In some embodiments, the device is supplied on a roll, or Z-folded flat pack, or as one of a plurality of individually supplied tape pieces each on release-paper substrate of like devices, each precut to a length and finishing-edge angle to prevent water buildup on a cable wrapped with the device.

### CROSS-REFERENCE TO RELATED APPLICATIONS

This application claims priority benefit, under 35 U.S.C. § 119(e), of U.S. Provisional Patent Application No. 62/815,519, filed Mar. 8, 2019 by Dakoda R. Hudak and titled “Coderyt,” U.S. Provisional Patent Application No. 62/821,296, filed Mar. 20, 2019 by Dakoda R. Hudak and titled “Color coding device,” U.S. Provisional Patent Application No. 62/827,123, filed Mar. 31, 2019 by Dakoda R. Hudak and titled “Color-coding device and method,” and U.S. Provisional Patent Application No. 62/829,518, filed Apr. 4, 2019 by Dakoda R. Hudak and titled “Color-coding device and method,” each of which is incorporated herein by reference in its entirety.

### FIELD OF THE INVENTION

This invention relates to the field of pre-cut adhesive tape, and more specifically to a method and apparatus for color-coding communications cables (e.g., cable flag tape and method) using pieces of pre-cut tape (in some embodiments, color-code tape that is stretchable during installation and that has pressure-sensitive adhesive), that are provided on a release liner that is formed to be removed as two or more pieces of release liner without the human user having to touch the adhesive face as the human user wraps the color-code tape around the communications cable.

### BACKGROUND OF THE INVENTION

Currently, conventional color coding of an electrical and/or fiber-optic communications cable is performed with pieces of colored tape cut from large rolls of bulk tape material, such as colored electrical tape having pressure-sensitive adhesive on the tape, and wrapped around the cable. The installation worker typically peels a length of tape from the roll and cuts the piece off using a utility knife (such as a box cutter or the like), scissors or diagonal cutters. A plurality of such pieces of tape are used, each piece of a selected particular color. Each piece is sometimes simply called a “color code” and is wrapped around the cable side-by-side to other such “color codes,” with a preferred spacing between the nearest wraps of color codes, and a specified sequential order of color codes for each particular cable. Each color-coded piece is wrapped several times around a communications cable (e.g., at least three circumferential layers are specified by some companies to meet their requirements). The order and colors of the color codes indicate what communications protocol is used by the cable, and identify one cable from the others at the point of installation. This conventional method leaves the possibility for errors in required lengths and installation errors (such as, for example, touching the adhesive with the fingers, rendering the adhesive less sticky, or having the tape fold over and stick to itself, or having the wrong spacing, wrap-to-wrap, between adjacent wraps of tapes on a cable). It is often desired to have the end of the tape cut at a desired diagonal angle, which is difficult and time consuming for the user to obtain using a utility knife, and the results are inconsistent from user to user. Additional problems that may be encountered include incorrect spacing, inability to accurately cost-manage materials used, flagging or peeling of installed color-coded tapes, and the need for the installer to continuously search for the accessible end of the roll of tape. This conventional method also leaves the possibility of accidentally self-inflicted user cuts, injuries and extended installation times due to the process described above, especially during cold or rainy weather.

Descriptions of various conventional adhesive tapes that include a release liner include patents on medical bandages and tape that releases from a wall when an end of the adhesive tape is pulled to stretch the tape. For example:

U.S. Pat. No. 4,744,355 issued to Faasse, Jr. on May 17, 1988 with the title “Hinged end wound dressing,” and is incorporated herein by reference. U.S. Pat. No. 4,744,355 describes a wound dressing in which the release liner halves are each divided into a release liner main body and a release liner edge strip. The release liner main body overlaps a portion of the edge strip and the two are hingedly secured together by a flexible hinge.

U.S. Pat. No. 5,088,483 issued to Heinecke on Feb. 18, 1992 with the title “Adhesive frame bandage,” and is incorporated herein by reference. U.S. Pat. No. 5,088,483 describes an adhesive composite having a conformable backing, a pressure-sensitive adhesive which is coated on at least a portion of the bottom surface of the backing, a permanent adhesive reinforcement which acts as reinforcing means for the backing, coated on the bottom surface of the film and a liner which is releasably applied to the adhesive coated surface of the backing. A delivery means may also be provided to allow delivery of the system without touching the adhesive. The permanent adhesive reinforcement is applied to the backing in an amount which is sufficient to provide some reinforcement to the thin film backing so that the composite wall not tend to fold back on itself or wrinkle under ordinary use. Preferably this permanent adhesive reinforcement is applied to the periphery of the backing.

U.S. Pat. No. 6,541,089 issued to Hamerski, et al. on Apr. 1, 2003 with the title “Stretch releasing adhesive tape with integral pull tab,” and is incorporated herein by reference. U.S. Pat. No. 6,541,089 describes an elongated length of a single or double-sided stretch-releasing adhesive tape that can be cut to a selected length with integral pull tabs for stretch-removing the tape from a substrate. The stretch-releasing adhesive tape can be provided as long strips or roll form. The elongated stretch-releasing adhesive tape article includes an elongate length of stretch-releasing adhesive tape defining a longitudinal axis. The stretch-releasing adhesive tape has a first surface and a second non-adhesive surface. The first surface includes one or more adhesive regions and one or more non-adhesive regions arranged along the longitudinal axis. At least a portion of the non-adhesive regions include a series of pull tabs arranged along the longitudinal axis that can be grasped in combination with the second non-adhesive surface by a user during stretch-removal of the tape from an associated substrate.

There remains a need for improved devices and methods for color coding communications cables and the like.

### SUMMARY OF THE INVENTION

Presently there is no conventional product that provides solutions for the problems described above. The present invention provides solutions to these problems by providing pre-cut color-coded pieces of tape, each on a release backing, with all the issues described above in mind.

How it works: In some embodiments, each color-coded device (e.g., a piece of colored tape supplied on a roll or a Z-folded flat pack, or as one of a plurality of individually supplied tape pieces each on release-paper substrate) includes a pre-cut color-coded polymer tape having pressure-sensitive adhesive, in which the precut lengths of tape are predetermined based on each cable size to provide the correct amount of color code needed (e.g., in some embodiments, the pre-cut length provides the amount of tape needed for three wrapped layers of tape around the circumference of the cable). In some embodiments, each piece has a precut finish end with a geometric shape (e.g., in some embodiments, a diagonal angle) on one end to prevent peeling and flagging. In some embodiments, the color-code device also has a removable release liner that extends width-wise wider than the adhesive tape, in order to provide accurate spacing between color codes as may be required for installation per requirements of the customer. In some embodiments, quick-peel tabs are provided to access the color code without the need to continuously search for the accessible end of a roll of tape, and without exposing the human installation user to harsh weather elements.

### BRIEF DESCRIPTION OF THE DRAWINGS

FIG. 1A1 is a top (plan) view of a color-code device 101, according to some embodiments of the present invention.

FIG. 1A2 is an end (elevation) view of color-code device 101, according to some embodiments of the present invention.

FIG. 1A3 is a side (elevation) view of color-code device 101, according to some embodiments of the present invention.

FIG. 1A4 is a top (plan) view of an alternative color-code device 104 having one or more side tabs 144 and/or 145, according to some embodiments of the present invention.

FIG. 1A4.1 is an end (elevation) view of color-code device 104, according to some embodiments of the present invention.

FIG. 1A5 is a top (plan) view of an alternative color-code device 105 having one or more side tabs 154 and/or 155, according to some embodiments of the present invention.

FIG. 1A5.1 is an end (elevation) view of color-code device 105, according to some embodiments of the present invention.

FIG. 1B is a perspective view of a portion of a cable 99 having one wrapped piece of color-code tape 110A, according to some embodiments of the present invention.

FIG. 1C is a perspective view of a portion of a cable 99 having one wrapped piece of color-code tape 110A, with a second piece of color-code tape 110B about to be applied, according to some embodiments of the present invention.

FIG. 1D is a perspective view of a portion of a cable 99 having one wrapped piece of color-code tape 110A, with a second piece of color-code tape 110B starting to be applied, according to some embodiments of the present invention.

FIG. 1E is a perspective view of a portion of a cable 99 having one wrapped piece of color-code tape 110A, with a second piece of color-code tape 110B further starting to be applied with more of the release liner starting to be removed out of the way, according to some embodiments of the present invention.

FIG. 1F is a perspective view of a portion of a cable 99 having two wrapped pieces of color-code tape 110A and 110B having been applied, according to some embodiments of the present invention.

FIG. 1G is a perspective view of a portion of a cable 99 having four wrapped pieces of color-code tape 110A, 110B, 110C and 110D having been applied, according to some embodiments of the present invention.

FIG. 2A1 is a top (plan) view of an alternative color-code device 201, according to some embodiments of the present invention.

FIG. 2A2 is an end (elevation) view of color-code device 201, according to some embodiments of the present invention.

FIG. 2A3 is a side (elevation) view of color-code device 201, according to some embodiments of the present invention.

FIG. 2A4 is a top (plan) view of an alternative color-code device 204 having printed human-perceptible indicia 292, according to some embodiments of the present invention.

FIG. 2B is a perspective view of a color-code device 201.1 as part of a roll-based system 200 having a plurality of color-code devices 201.1-201.n, according to some embodiments of the present invention.

FIG. 2C is a perspective view of a portion of a cable 99 having one wrapped piece of color-code tape 110A, with a second piece of color-code tape 110B about to be applied from roll 230, according to some embodiments of the present invention.

FIG. 3A1 is a top (plan) view of an alternative color-code device 301, according to some embodiments of the present invention.

FIG. 3A2 is an end (elevation) view of color-code device 301, according to some embodiments of the present invention.

FIG. 3A3 is a side (elevation) view of color-code device 301, according to some embodiments of the present invention.

FIG. 3B is a perspective view of a color-code device 301.1 as part of a roll-based system 300 having a plurality of color-code devices 301.1-301.n, according to some embodiments of the present invention.

FIG. 3C is a perspective view of a portion of a cable 99 having one wrapped piece of color-code tape 110A, with a second piece of color-code tape 110B about to be applied from roll 330, according to some embodiments of the present invention.

FIG. 4A1 is a top (plan) view of an alternative color-code device 401, according to some embodiments of the present invention.

FIG. 4A2 is an end (elevation) view of color-code device 401, according to some embodiments of the present invention.

FIG. 4A3 is a side (elevation) view of color-code device 401, according to some embodiments of the present invention.

FIG. 4A4 is a backside view of color-code device 401, according to some embodiments of the present invention.

FIG. 4B is a perspective view of a cable 99 having one wrapped piece of color-code tape 110A, with second tape 110B on color-code device 401′ about to be applied, according to some embodiments of the present invention.

FIG. 4C is a perspective view of a portion of a cable 99 having one wrapped piece of color-code tape 110A, with a second piece of color-code tape 110B about to be applied from color-code device 401′, according to some embodiments of the present invention.

FIG. 5A1 is a top (plan) view of an alternative color-code device 501, according to some embodiments of the present invention.

FIG. 5A2 is an end (elevation) view of color-code device 501, according to some embodiments of the present invention.

FIG. 5A3 is a side (elevation) view of color-code device 501, according to some embodiments of the present invention.

FIG. 5A4 is a top (plan) view of an alternative color-code device 504 having printed human-perceptible indicia 592, according to some embodiments of the present invention.

FIG. 5B is a perspective view of a color-code device 501.1 as part of a roll-based system 500 having a plurality of color-code devices 501.1-501.n, according to some embodiments of the present invention.

FIG. 5C is a perspective view of a portion of a cable 99 having one wrapped piece of color-code tape 510A, with a second piece of color-code tape 510B about to be applied from roll 530, according to some embodiments of the present invention.

FIG. 6A1 is a top (plan) view of an alternative color-code device 601, according to some embodiments of the present invention.

FIG. 6A2 is an end (elevation) view of color-code device 601, according to some embodiments of the present invention.

FIG. 6A3 is a side (elevation) view of color-code device 601, according to some embodiments of the present invention.

FIG. 6B is a perspective view of a color-code device 601.1 as part of a roll-based system 600 having a plurality of color-code devices 601.1-601.n, according to some embodiments of the present invention.

FIG. 6C is a perspective view of a portion of a cable 99 having one wrapped piece of color-code tape 510A, with a second piece of color-code tape 510B about to be applied from roll 630, according to some embodiments of the present invention.

### DESCRIPTION OF PREFERRED EMBODIMENTS

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The embodiments shown in the Figures and described here may include features that are not included in all specific embodiments. A particular embodiment may include only a subset of all of the features described, or a particular embodiment may include all of the features described.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

Certain marks referenced herein may be common-law or registered trademarks of third parties affiliated or unaffiliated with the applicant or the assignee. Use of these marks is for providing an enabling disclosure by way of example and shall not be construed to limit the scope of the claimed subject matter to material associated with such marks.

CodeRyt

Some embodiments of the present invention are given the name CodeRyt™. CodeRyt™ is designed to help aid in the color-coding process used in various industries. In some embodiments, the length and width of each pre-cut piece of colored tape is determined by the size of the circumference of the cables to be coded and the number of ultimate wraps as specified by the design engineers of the project (e.g., in some embodiments, half-inch cables will utilize about 4.7124 inches of color code tape. In some embodiments, the release liner will be two pieces, one or more of which will have a quick-peel tab, wherein the first release liner will be two inches long for the starting side and five inches long for the ending side for the remaining piece of color code tape). In some embodiments, each CodeRyt™ piece of tape also has a diagonal angle cut for the finish end (the end of the outer-most layer), which in some embodiments, includes a 35-degree angle cut on the finished end to reduce water settling at the outermost end, in order to provide resistance against peeling in different climate or weather conditions. This pre-cut diagonal end eliminates the need for the use of a knife or scissors, thus providing a safer, faster application. In some embodiments, the release liner provides a built-in guide that extends to one side (or in other embodiments, both sides) for accurate spacing relative to other additional color coding, providing a more accurate professional result, no matter how experienced the end user may be. In some embodiments, the release liner also has a peel-able quick tab for the removal of the release liner covering the starting point on the code tape. This allows for fast-start application and removal in harsh conditions without the need for great dexterity, since once the initial attachment is made, the remaining peel-able quick tab release liner is pulled along with the color-code application until the remaining Coderyt™ is applied in a tight, uniform fashion.

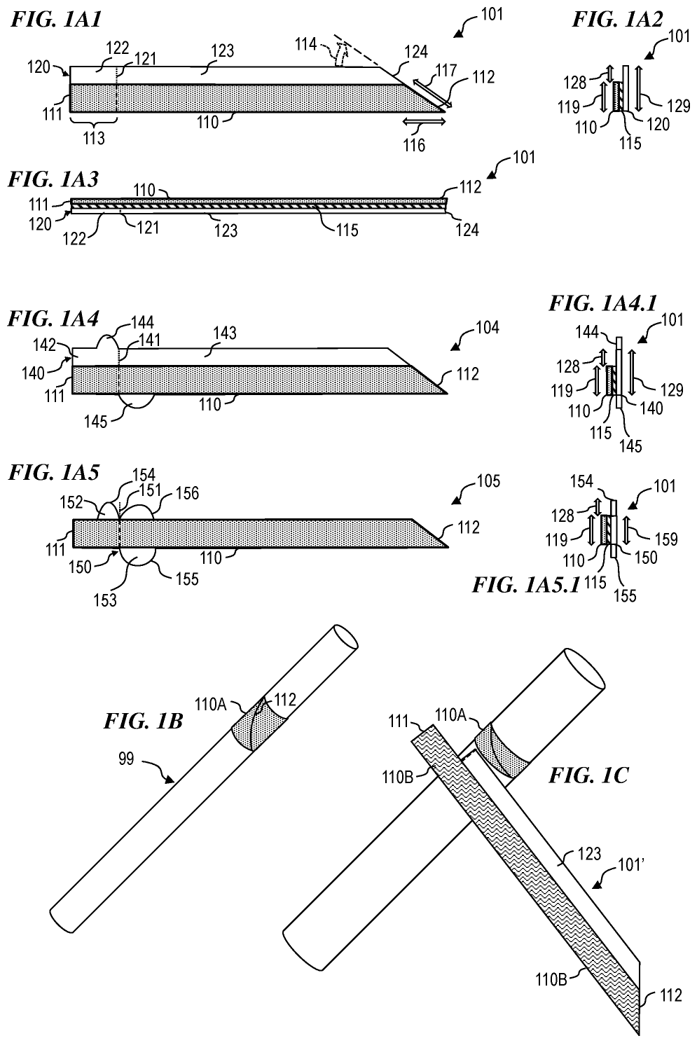

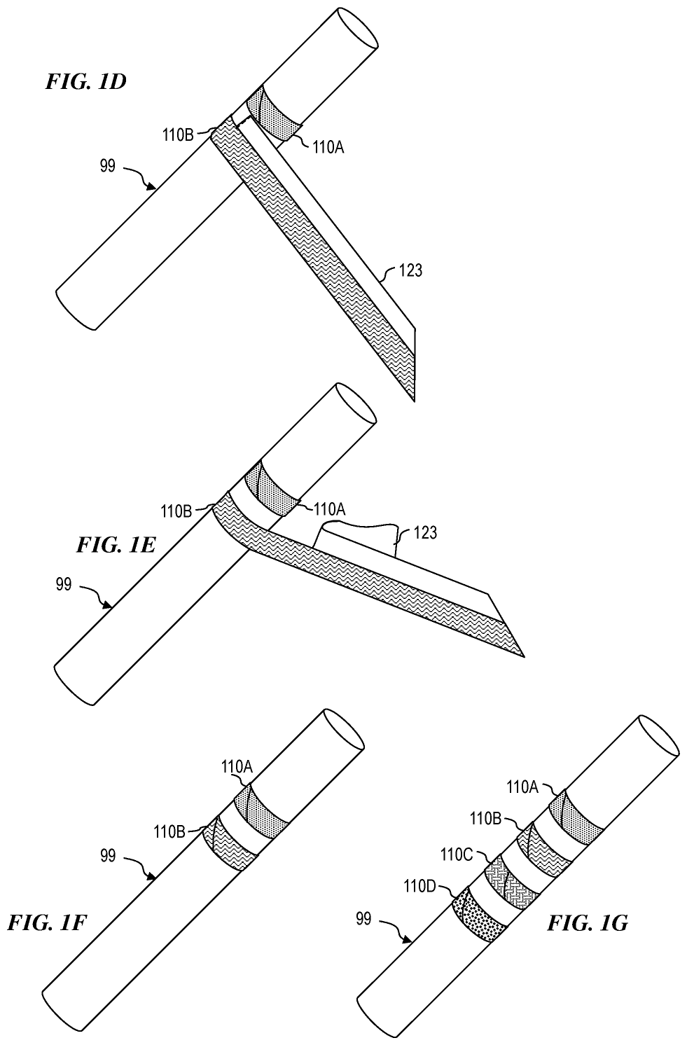

FIG. 1A1 is a top (plan) view of a color-code device 101, according to some embodiments of the present invention. In some embodiments, color-code device 101 includes a length of tape 110 having a start end 111 (which will be the end of the inner-most layer when tape 110 is wrapped around a cable 99 (see FIG. 1B)), and a finish end 112 (which will be the end of the outer-most layer when tape 110 is wrapped around a cable 99). In some embodiments, tape 110 includes a polymer substrate with a non-adhesive outer surface and a pressure-sensitive adhesive on the inner surface (the surface that is stuck to the outer surface of the cable 99). In some embodiments, tape 110 is made from 3M Scotch Vinyl Color Coding Electrical Tape 35, ¾-inch wide, or the like (Scotch® Vinyl Electrical Tape 35 is a premium-grade, 7-mil thick polyvinyl chloride (PVC) color-coding tape, such as available in a plurality of colors from 3M Company, St. Paul, Minn.).

In some embodiments, the tape 110 has the following properties:

| | |
|---|---|
| Adhesion Strength | 30 Ounce, 40 Ounce |
| Adhesion to Steel | 2.2 N/cm, 20 oz/in (2.2 N/cm) |
| Adhesion to Steel oz/in | 30 (33), 40 (44) |
| (N/100 mm) | |
| Adhesive Material | Rubber Resin |
| Adhesive Type | Rubber |
| Agency Approvals | CSA Certified, UL Listed |
| Applications | Electrical Maintenance |
| Backing Material | Polyvinyl Chloride, Vinyl |
| Backing Thickness (Metric) | 0.18 mm |
| Brand | Scotch ® |
| Breaking Strength | 17 lb./in |
| Chemical Resistant | Yes |
| Color | Blue, Brown, Gray, Green, Orange, |
| | Pink, Red, Violet, White, Yellow |
| Dielectric Strength | 1250 V/mil |
| Dielectric Strength (V/mil) | 1250, 1250 V/mil |
| Electrolytic Corrosion Factor | 0.9 |
| Elongation | 225% |
| Elongation at Break | 2.25, 225% |
| Family | Scotch ® Vinyl Color Coding |
| | Electrical Tape 35 |
| Flame Retardant | Yes |
| Insulated | Yes |
| Insulation Resistance | >10\hat{ }6 megohms |
| Length | 20 Linear Foot, 66 Linear Foot |
| Length (Metric) | 20 m, 20.1, 20.1 m, 6.1 m |
| Lubricant Type | Gel |
| Material | PVC |
| Operating Temperature | 0° C. to 105° C., Up to 105 |
| (Celsius) | Degree Celsius |
| Operating Temperature | 32° F. to 220° F. |
| (Fahrenheit) | |
| Performance Level | Professional Grade |
| Product Type | Vinyl Electrical Tapes |
| Recovered Wall Thickness | 0.113 in |
| RoHS 2011/65/EU Compliant | Yes |
| RoHS EU Comments | RoHS 2011/65/EU compliant |
| | without exemption |
| Rolls per Carton | 10 |
| Rolls per Case | 100 |
| Round Size (Diameter) | 15 kV), 2½ to 4 Inch (for 5 kV |
| Self-extinguishing | No |
| Self-sticking | No |
| Shelf Life | 5 Year |
| Solution for | Wireless Network: Infrastructure |
| | Accessories |
| Specifications | VDE 0340-TEIL1 |
| Suitable for High Voltage | For marking only |
| Tape Grade | Premium |
| Tape Length (Metric) | 20 m, 33 m, 55 m |
| Tape Total Thickness | 7 Milli-inch |
| Tape Total Thickness (Metric) | 0.177 mm |
| Tape Type | Vinyl |
| Tape Width (Metric) | 12 mm, 19 mm |
| Tensile Strength lb./in | 9 (158), 90 (1577) |
| (N/100 mm) | |
| Thickness | 7, 7 mil |
| Thickness (Metric) | 0.177, 0.177 mm, 0.178 mm |
| Total Thickness | 0.18 mm |
| UL File Number | E129200 |
| UV Resistant | Yes |
| Voltage | 35 kV, 600 V |
| Voltage Application | Low Voltage |
| Voltage Range | 0-600 V |
| Voltage Rating | 600 V |
| Vulcanizing | No |
| Width | 0.5 in, 0.75 in |
| Width (Metric) | 12 mm, 12.7 mm, 19, |
| | 19 mm, 19.05 mm |

Each piece of color-code tape, according to the invention, is cut to the predetermined length and shaped at the finished end to have a diagonal edge that, when wrapped around a cable, sheds water better than a perpendicular finish edge that tends to gather water, and to delaminate or come loose and become a flag in the wind. In some embodiments, for example, the length is predetermined to provide three consecutive layers of tape when wrapped; in some such embodiments, a length equal to the cable diameter times pi times three, so for a cable of 0.5″ diameter (1.27 mm diameter), the length is about 0.5*pi*3=4.713″ (about 11.9 mm length); in some such embodiments, this length is the length from the start-end edge to the nearest end of the diagonal finish-end edge equal to the shortest of the two length-wise edges. In some embodiments, an additional 0.1 to 0.3 inches is provided to account for the thickness of the tape when the three layers are stacked around each other. Thus, in some embodiments, the longer of the two long edges is about 5″ long. For metric units, a person of skill in the art recognizes that each inch is 2.54 cm, so each inch-based measurement set forth can be multiplied by 2.54 to obtain the length in centimeters. In some embodiments, color-code devices 101 are supplied in kits having 10, 25 or 100 pre-cut color-code devices 101.

In some embodiments, tape 110 has a start end 111 (in some embodiments, substantially perpendicular to the longest edge of tape 110) and a finish end 112 that is at a non-perpendicular (i.e., diagonal) angle to the longest edge of tape 110 (i.e., at an acute angle 114 to the longest edge of tape 110, which, in some embodiments, is about 35 degrees). In other embodiments, other angles are used, wherein the angle is chosen such that the cosine of the angle 114 times the length of the finish edge 112 (equal to length 116 on FIG. 1A1) is at least 50% times the circumference of the cable, in order that the diagonal finish edge wraps around at least 50% of the cable circumference to shed water and reduce the amount of water from rain or dew that settles along that edge, thus reducing the tendency of the finish end 112 of the tape 110 to come loose from cable 99 once applied. In other words, in some embodiments, the angle 114 is selected so that the length 116 is at least 60% of the cable circumference. For example, when the width 116 of the tape 110 is 0.75″ and angle 114 is 35 degrees, then length 117 of finish edge 112 is about 1.31″, and distance 116 is about 1.07″, which is about 68% (i.e., more than 60%) of the 1.57″ circumference of a 0.5″-diameter cable.

In some other embodiments, the angle 114 is selected so that the length 116 is at least 50% of the cable circumference. As an example, when the width 116 of the tape 110 is 0.75″ and angle 114 is about 43 degrees or less, then length 117 of finish edge 112 is about 1.10″ or more, and distance 116 is about 0.084″ or more, which is at least about 51% (i.e., more than 50%) of the 1.57″ circumference of a 0.5″-diameter cable.

In some other embodiments, the angle 114 is selected so that the length 116 is at least 40% of the cable circumference. For example, when the width 116 of the tape 110 is 0.75″ and angle 114 is 50 degrees or less, then length 117 of finish edge 112 is about 0.98″ or more, and distance 116 is about 0.63″ or more which is about 40.06% (i.e., more than 40%) of the 1.57″ circumference of a 0.5″-diameter cable.

In some other embodiments, the angle 114 is selected so that the length 116 is at least 25% of the cable circumference. For example, when the width 116 of the tape 110 is 0.75″ and angle 114 is 62 degrees, then length 117 of finish edge 112 is about 0.85″, and distance 116 is about 0.399″ which is about 25.3% (i.e., more than 25%) of the 1.57″ circumference of a 0.5″-diameter cable.

In some embodiments, color-code device 101 includes a release liner 120 that has a cut and/or perforated line feature 121 that permits easy removal of release-liner portion 122 from the start end 111 of the adhesive tape 110 to the perforated line feature 121, thus exposing the pressure-sensitive adhesive 115 (see FIG. 1A2) of the portion 113 of tape 110 previously covered by release-liner portion 122, while release-liner portion 123 remains in place to protect the rest of the pressure-sensitive adhesive 115 from fingerprints and from sticking to itself. In some embodiments, the portion 113 is about one inch long to provide a firm starting adhesion to the cable being wrapped. In other embodiments, other lengths for portion 113 are used. In some embodiments, the finish end 124 of the release liner 120 is pre-cut flush even with the end 112 of tape 110.

FIG. 1A2 is an end (elevation, but not to scale) view of color-code device 101, according to some embodiments of the present invention. In some embodiments, release liner 120 has a width 129 that is wider than the width 119 of tape 110, and the extra width 128 is provided only to one side of tape 110 and, in some embodiments, is used by the human user to obtain the proper spacings between the individually wrapped pieces of color-code tape 110A, 110B, and the like (See FIG. 1G). For example, in some embodiments, the width 129 of release liner 120 is 1.5-inches wide and the width 119 of the tape 110 is 0.75-inches wide, so that the extra exposed width 128 of the release liner 120 (i.e., 0.75 inches) can be used to obtain a 0.75-inch spacing between wrapped pieces of tape 110.

FIG. 1A3 is a side (elevation, but not to scale) view of color-code device 101, according to some embodiments of the present invention. In some embodiments, color-code device 101 includes a vinyl-tape substrate 110, a pressure-sensitive adhesive layer 115 affixed to tape substrate 110 and covered by release liner 120.

FIG. 1A4 is a top (plan) view of an alternative color-code device 104 having one or more side tabs 144 and/or 145, according to some embodiments of the present invention. In some such embodiments, the release liner 140 is similar to release liner 110, but with the addition of one or more side tabs 144 and/or 145 that may make it easier to grasp when removing the pieces 142 and the remaining part of release liner 140, especially in cold and/or wet weather. In addition, tab 145 has a width (the distance as measured from the edge of tape 110) that may be utilized as a wrap-to-wrap (side-to-side) spacing between color codes when application is easier in orders other than the order usually used.

FIG. 1A4.1 is an end (elevation, but not to scale) view of color-code device 104, according to some embodiments of the present invention.

FIG. 1A5 is a top (plan) view of an alternative color-code device 105 having one or more side tabs 154 and/or 155, according to some embodiments of the present invention. In some such embodiments, the release liner 150 is similar to release liner 140, but with a width 159 that is substantially the same as the width 119 of tap 110 and with the addition of side tabs 154 and/or 145 that may make it easier to grasp when removing the pieces 142 and the remaining part of release liner 140, especially in cold and/or wet weather. In addition, tabs 155 and 156 each have a width (the distance as measured from the edge of tape 110) that may be utilized as a wrap-to-wrap (side-to-side) spacing between color codes when application of an additional color code wrapped next to existing wrapped color codes is easier in orders other than the order (left-to-right or right-to-left) usually used.

FIG. 1A5.1 is an end (elevation, but not to scale) view of color-code device 105, according to some embodiments of the present invention.

FIG. 1B is a perspective view of a portion of a cable 99 having one wrapped piece of color-code tape 110A, according to some embodiments of the present invention.

FIG. 1C is a perspective view of a portion of a cable 99 having one wrapped piece of color-code tape 110A, with a second piece of color-code tape 110B about to be applied, according to some embodiments of the present invention.

FIG. 1D is a perspective view of a portion of a cable 99 having one wrapped piece of color-code tape 110A, with a second piece of color-code tape 110B starting to be applied, according to some embodiments of the present invention.

FIG. 1E is a perspective view of a portion of a cable 99 having one wrapped piece of color-code tape 110A, with a second piece of color-code tape 110B further starting to be applied with more of the release liner starting to be removed out of the way, according to some embodiments of the present invention.

FIG. 1F is a perspective view of a portion of a cable 99 having two wrapped pieces of color-code tape 110A and 110B having been applied, according to some embodiments of the present invention.

FIG. 1G is a perspective view of a portion of a cable 99 having four wrapped pieces of color-code tape 110A, 110B, 110C and 110D having been applied, according to some embodiments of the present invention. In some embodiments, tape 110 is 0.75-inches wide, and the tape-to-tape spacing 128′ is equal to the extra exposed width 128 of the release liner 120 (i.e., 0.75 inches). In other embodiments, the tape-to-tape spacing 128′ is chosen to be another dimensional value, not necessarily equal to the tape width 119. Note that the Figures herein are not necessarily to scale of all embodiments.

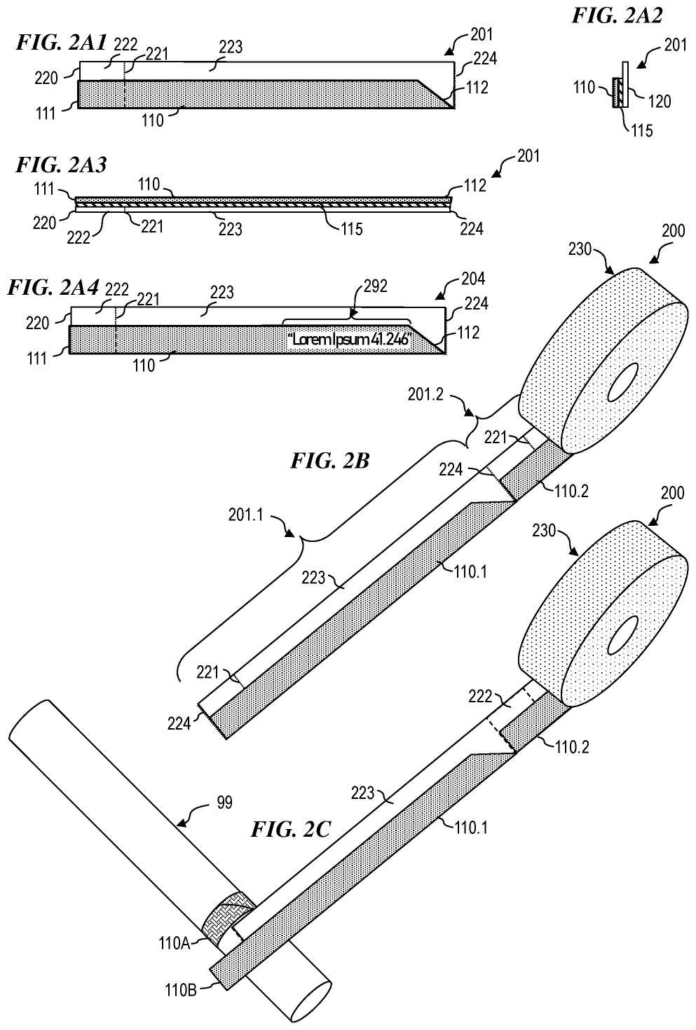

FIG. 2A1 is a top (plan) view of an alternative color-code device 201, according to some embodiments of the present invention. In some embodiments, color-code devices 101 are supplied in rolls having 10, 25 or 100 color-code devices 201 separable at perforation lines 224. In some embodiments, color-code devices 201 are supplied in “Z” folded flat packs of 10, 25 or 100 separable color-code devices 201.

FIG. 2A2 is an end (elevation, but not to scale) view of color-code device 201, according to some embodiments of the present invention.

FIG. 2A3 is a side (elevation, but not to scale) view of color-code device 201, according to some embodiments of the present invention.

FIG. 2A4 is a top (plan) view of an alternative color-code device 204, that besides having an optional color coding, also includes printed human-perceptible indicia 292 (such as a reference or description of the communications technology, protocol, speed and the like, and/or a serial number indicating which cable is which), that replace or supplement the color coding provided by the tape, according to some embodiments of the present invention. In some embodiments, any other of the embodiments described herein optionally includes printed human-perceptible indicia 292.

FIG. 2B is a perspective view of a color-code device 201.1 as part of a roll-based system 200 having a plurality of color-code devices 201.1-201.n, according to some embodiments of the present invention.

FIG. 2C is a perspective view of a portion of a cable 99 having one wrapped piece of color-code tape 110A, with a second piece of color-code tape 110B about to be applied from roll 230, wherein end piece 222 of release liner 220 has been torn off at perforation line 221 and discarded to expose the end of tape piece 110B, so that tape 110B can be wrapped around cable 99, according to some embodiments of the present invention.

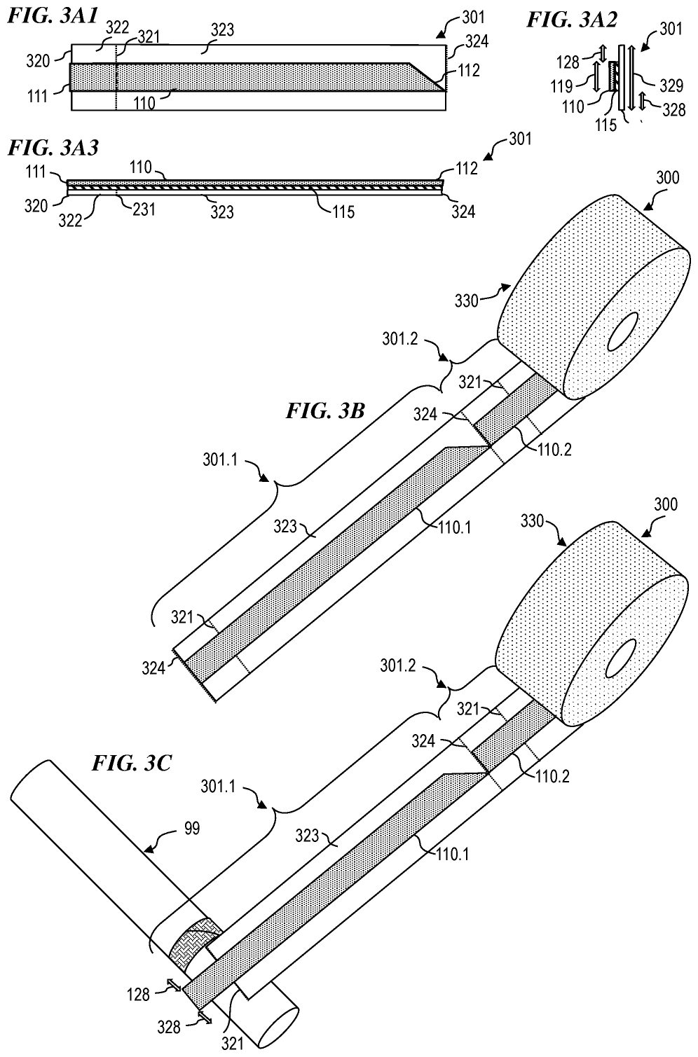

FIG. 3A1 is a top (plan) view of an alternative color-code device 301, according to some embodiments of the present invention. In some such embodiments, release liner 320 is wider than tape 110 so that the side edges extend beyond the width of tape 110 on both sides. In some embodiments, color-code device 301 includes a release liner 320 that has a cut and/or perforated line feature 321 that permits easy removal of release-liner portion 322 from the start end 111 of the adhesive tape 110 to the perforated line feature 321, thus exposing the pressure-sensitive adhesive 115 (see FIG. 3A2) of the portion 113 of tape 110 previously covered by release-liner portion 322, while release-liner portion 323 remains in place to protect the rest of the pressure-sensitive adhesive 115 from fingerprints and from sticking to itself. In some embodiments, the portion 113 is about one inch long to provide a firm starting adhesion to the cable being wrapped. In other embodiments, other lengths for portion 113 are used.

FIG. 3A2 is an end (elevation) view of color-code device 301, according to some embodiments of the present invention. In some such embodiments, release liner 320 is wider than tape 110 so that the side edges extend beyond the width of tape 110 on both sides, such that extra width 128 provides a guide for the user as to spacing on one side and extra width 328 provides a guide for the user as to spacing on the opposite side. In this way, either spacing 128 or 328 may be used, depending on which successive direction along cable 99 the tape pieces 110A, 110B, . . . are being applied.

FIG. 3A3 is a side (elevation) view of color-code device 301, according to some embodiments of the present invention.

FIG. 3B is a perspective view of a color-code device 301.1 as part of a roll-based system 300 having a plurality of color-code devices 301.1-301.n, according to some embodiments of the present invention.

FIG. 3C is a perspective view of a portion of a cable 99 having one wrapped piece of color-code tape 110A, with a second piece of color-code tape 110B about to be applied from roll 330, according to some embodiments of the present invention. Here, end piece 322 of release liner 320 has been torn off at perforation line 321 and discarded to expose the end of tape piece 110B, so that tape 110B can be wrapped around cable 99, according to some embodiments of the present invention.

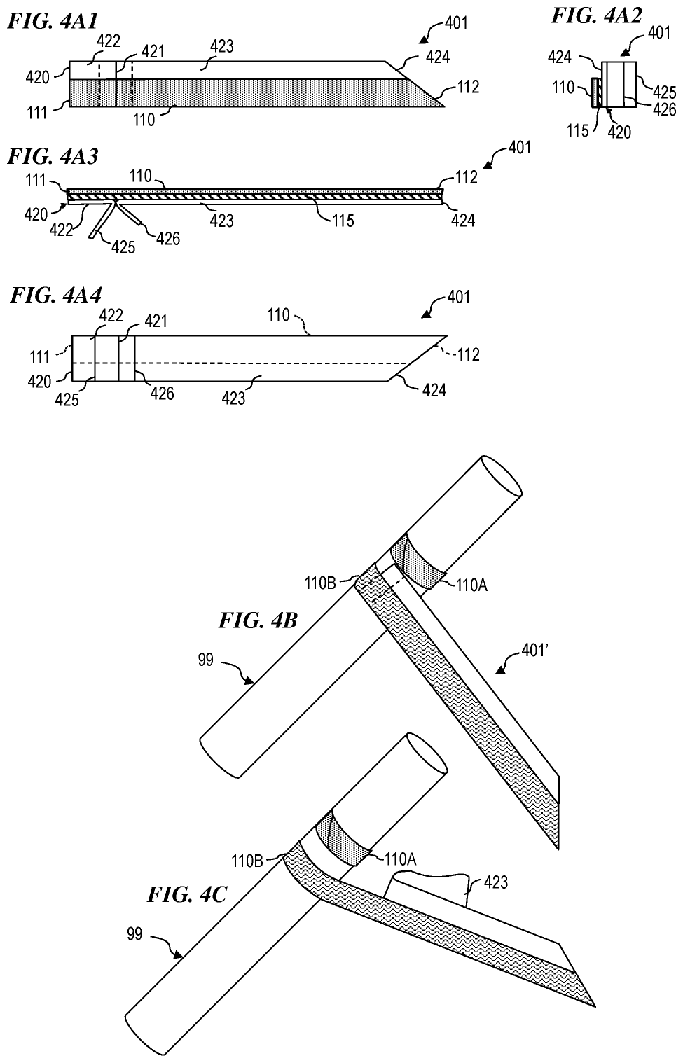

FIG. 4A1 is a top (plan) view of an alternative color-code device 401, according to some embodiments of the present invention. In some such embodiments, release liner 420 is wider than tape 110 so that the side edges of release liner 420 extend beyond the width of tape 110 on one side (as shown here) or on both sides (not shown, but similar to FIG. 3A1). In some embodiments, color-code device 401 includes a two-part release liner 420 that has tab features 425 and 426 that are folded at the line 421 where they meet, wherein, in some embodiments, the tab 425 is longer to make tab 425 the prime piece to grab (e.g., in some embodiments, tab 425 is 0.625 inches (15.9 mm) long and tab 426 is 0.375 inches (9.53 mm) long), which permits easy removal of release-liner portion 422 from the start end 111 of the adhesive tape 110 to the fold-line feature 421, thus exposing the pressure-sensitive adhesive 115 (see FIG. 4A2) of the portion 113 of tape 110 previously covered by release-liner portion 422, while release-liner portion 423 remains in place to protect the rest of the pressure-sensitive adhesive 115 from fingerprints and from sticking to itself. In some embodiments, the portion 113 is about one inch long to provide a firm starting adhesion to the cable being wrapped. In other embodiments, other lengths for portion 113 are used. In some embodiments (not shown), a plurality of color-code devices 401 are provided as a kit of pre-selected colors to a particular cable-installation job. In some embodiments, a plurality of color-code devices 401 are provided on a roll such as shown in FIG. 2B or FIG. 3B or FIG. 5B or FIG. 6B. In some embodiments, the finish end 424 of the release liner 420 is pre-cut flush even with the end 112 of tape 110.

FIG. 4A2 is an end (elevation) view of color-code device 401, according to some embodiments of the present invention.

FIG. 4A3 is a side (elevation) view of color-code device 401, according to some embodiments of the present invention.

FIG. 4A4 is a backside view of color-code device 401, according to some embodiments of the present invention.

FIG. 4B is a perspective view of a cable 99 having one wrapped piece of color-code tape 110A, with second tape 110B on color-code device 401′ (401′ represents color-code device 401 after release-liner portion 422 has been removed) about to be applied, according to some embodiments of the present invention.

FIG. 4C is a perspective view of a portion of a cable 99 having one wrapped piece of color-code tape 110A, with a second piece of color-code tape 110B about to be applied from color-code device 401′, according to some embodiments of the present invention.

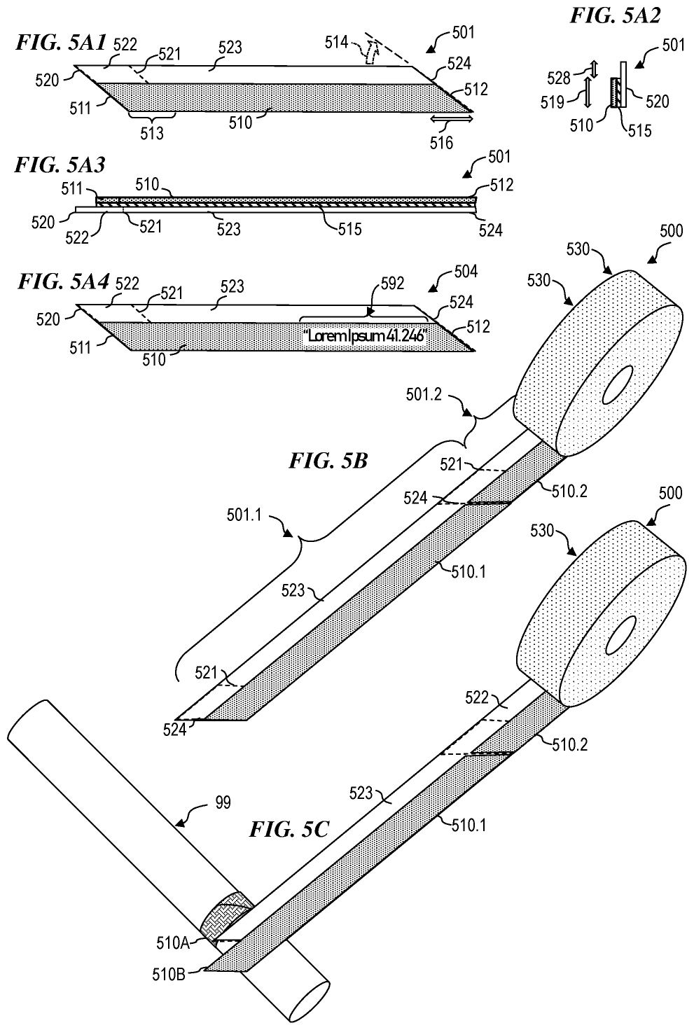

FIG. 5A1 is a top (plan) view of an alternative color-code device 501, according to some embodiments of the present invention. In some such embodiments, release liner 520 is wider than tape 510 so that the side edges extend beyond the width of tape 510 on both sides. In some embodiments, color-code device 501 includes a release liner 520 that has a cut and/or perforated line feature 521 that permits easy removal of release-liner portion 522 from the start end 511 of the adhesive tape 510 to the perforated line feature 521, thus exposing the pressure-sensitive adhesive 515 (see FIG. 5A2) of the portion 513 of tape 510 previously covered by release-liner portion 522, while release-liner portion 523 remains in place to protect the rest of the pressure-sensitive adhesive 515 from fingerprints and from sticking to itself. In some embodiments, the portion 513 is about one inch long to provide a firm starting adhesion to the cable being wrapped. In other embodiments, other lengths for portion 513 are used.

In some embodiments, color-code devices 501 are supplied in rolls having 10, 25 or 100 color-code devices 501 separable at perforation lines 524. In some embodiments, color-code devices 501 are supplied in “Z” folded flat packs of 10, 25, 55 or 100 separable color-code devices 501. In some embodiments, color-code devices 501 are supplied in kits or packs of 10, 55 or 100 separate color-code devices 501.

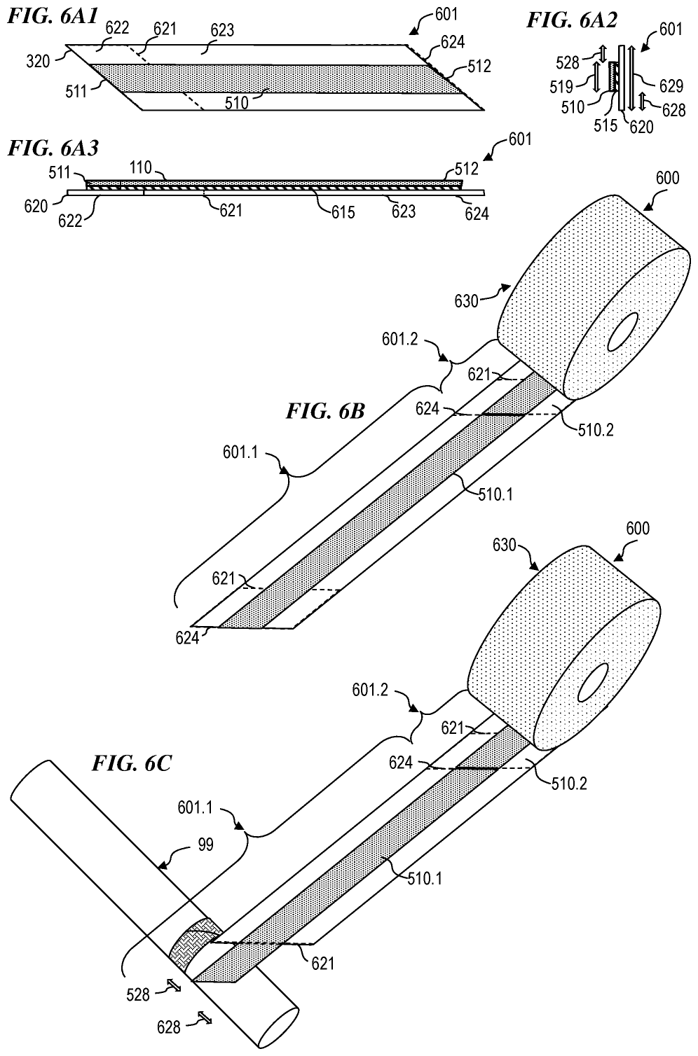

In some embodiments, tape 510 has a start end 511 (in some embodiments, diagonal and substantially parallel to the finish end 512 of tape 510, e.g., the same cut that formed the finish end 512 on one piece of tape 510 also formed the start end 511 of the next piece of tape 510—in some embodiments, this allows a single cut direction for processing an entire roll of devices 501; this also applies to devices such as 601 of FIG. 6A1) and a finish end 512 that is at a non-perpendicular (i.e., diagonal) angle to the longest edge of tape 510 (i.e., at an acute angle 514 to the longest edge of tape 510, which, in some embodiments, is about 35 degrees). In other embodiments, other angles are used, wherein the angle is chosen such that the cosine of the angle 514 times the length of the finish edge 512 (cosine of angle 514 time 512 is equal to length 516 on FIG. 5A1) is at least 50% times the circumference of the cable, in order that the diagonal finish edge wraps around at least 50% of the cable circumference to shed water and reduce the amount of water from rain or dew that settles along that edge, thus reducing the tendency of the finish end 512 of the tape 510 to come loose from cable 99 once applied. In other words, in some embodiments, the angle 514 is selected so that the length 516 is at least 60% of the cable circumference. For example, when the width 516 of the tape 510 is 0.75″ and angle 514 is 35 degrees, then length 517 of finish edge 512 is about 1.31″, and distance 116 is about 1.07″ which is about 68% (i.e., more than 60%) of the 1.57″ circumference of a 0.5″-diameter cable.

FIG. 5A2 is an end (elevation, but not to scale) view of color-code device 501, according to some embodiments of the present invention.

FIG. 5A3 is a side (elevation, but not to scale) view of color-code device 501, according to some embodiments of the present invention.

FIG. 5A4 is a top (plan) view of an alternative color-code device 504, that, besides having an optional color coding, also includes printed human-perceptible indicia 592 (such as a reference or description of the communications technology, protocol, speed and the like, and/or a serial number indicating which cable is which), that replace or supplement the color coding provided by the tape, according to some embodiments of the present invention. In some embodiments, any other of the embodiments described herein optionally includes printed human-perceptible indicia 592.

FIG. 5B is a perspective view of a color-code device 501.1 as part of a roll-based system 500 having a plurality of color-code devices 501.1-501.n, according to some embodiments of the present invention.

FIG. 5C is a perspective view of a portion of a cable 99 having one wrapped piece of color-code tape 510A, with a second piece of color-code tape 510B about to be applied from roll 530, wherein end piece 522 of release liner 520 has been torn off at perforation line 221 and discarded to expose the end of tape piece 510B, so that tape 510B can be wrapped around cable 99, according to some embodiments of the present invention.

FIG. 6A1 is a top (plan) view of an alternative color-code device 601, according to some embodiments of the present invention. In some such embodiments, release liner 620 is wider than tape 510 so that the side edges extend beyond the width of tape 510 on both sides. In some embodiments, color-code device 601 includes a release liner 620 that has a cut and/or perforated line feature 621 that permits easy removal of release-liner portion 622 from the start end 511 of the adhesive tape 510 to the perforated line feature 621, thus exposing the pressure-sensitive adhesive 515 (see FIG. 6A2) of the portion 513 of tape 510 previously covered by release-liner portion 622, while release-liner portion 623 remains in place to protect the rest of the pressure-sensitive adhesive 515 from fingerprints and from sticking to itself. In some embodiments, the portion 513 is about one inch long to provide a firm starting adhesion to the cable being wrapped. In other embodiments, other lengths for portion 513 are used.

FIG. 6A2 is an end (elevation) view of color-code device 601, according to some embodiments of the present invention. In some such embodiments, release liner 620 is wider than tape 510 so that the side edges extend beyond the width of tape 510 on both sides, such that extra width 528 provides a guide for the user as to spacing on one side and extra width 628 provides a guide for the user as to spacing on the opposite side. In this way, either spacing 528 or 628 may be used, depending on which successive direction along cable 99 the tape pieces 510A, 510B, . . . are being applied.

FIG. 6A3 is a side (elevation) view of color-code device 601, according to some embodiments of the present invention.

FIG. 6B is a perspective view of a color-code device 601.1 as part of a roll-based system 600 having a plurality of color-code devices 601.1-601.n, according to some embodiments of the present invention.

FIG. 6C is a perspective view of a portion of a cable 99 having one wrapped piece of color-code tape 510A, with a second piece of color-code tape 510B about to be applied from roll 630, according to some embodiments of the present invention. Here, end piece 622 of release liner 620 has been torn off at perforation line 621 and discarded to expose the end of tape piece 510B, so that tape 510B can be wrapped around cable 99, according to some embodiments of the present invention.

Some embodiments of the invention use a method that includes providing a color-code device (101, 201, 302, 401, 501, 601) having a first pre-cut piece of tape (110, 510) having an adhesive surface covered by a release liner (120, 220, 320, 420, 520, 620), wherein the first pre-cut piece of tape (110, 510) has a starting end (111, 511) and a finish end (112, 512), and wherein the finish end (112, 512) has a diagonal edge at an acute angle to a lengthwise edge of the piece of tape (110, 510); removing a first piece (122, 222, 322, 422, 522, 622) of the release liner (120, 220, 320, 420, 520, 620); and beginning with the start end (111, 511), wrapping the first piece of tape (110, 510) around a communications cable while removing a remaining piece (123, 223, 323, 423, 523, 623) of the release liner (120, 220, 320, 420, 520, 620).

Some embodiments of the method further include having a second pre-cut piece of tape (110, 510) having an adhesive surface covered by a release liner (120, 220, 320, 420, 520, 620), wherein the first pre-cut piece of tape (110, 510) has a starting end (111, 511) and a finish end (112, 512), and wherein the finish end (112, 512) has a diagonal edge at an acute angle to a lengthwise edge of the piece of tape (110, 510); removing a first piece (122, 222, 322, 422, 522, 622) of the release liner (120, 220, 320, 420, 520, 620); and beginning with the start end (111, 511), wrapping the first piece of tape (110, 510) around a communications cable while removing a remaining piece (123, 223, 323, 423, 523, 623) of the release liner (120, 220, 320, 420, 520, 620).

In some embodiments, the present invention provides an apparatus for color-coding cable that includes: a color-code device (101, 201, 302, 401, 501, 601) having a first pre-cut piece of tape (110, 510) having an adhesive surface covered by a release liner (120, 220, 320, 420), wherein the first pre-cut piece of tape (110, 510) has a starting end (111, 511) and a finish end (112, 512), and wherein the finish end (112, 512) has a diagonal edge at an acute angle to a lengthwise edge of the piece of tape (110, 510).

In some embodiments, the apparatus includes a roll (220, 320, 520, 620) having a plurality of color-code devices (201, 301, 501, 601), and wherein the plurality of color-code devices includes the first color-code device.

Some embodiments of the apparatus further include at least one sideways-extending tab (144, 145 154, 155 and/or 156) on the release liner.

In some embodiments of the apparatus, the release liner including a first release liner piece (422) having a center end tab (425) and a second release liner piece (426) having a center end tab (426), each end tab extending from a center fold line in a direction away from the piece of tape (110).

In some embodiments of the apparatus, the release liner is wider than the piece of tape (110, 510), and wherein the tape is aligned closer to a first side of the release liner such that the release liner extending away from the tape to a second opposite side provides a spacing distance guide for installation of a plurality of such pieces of tape.

In some embodiments of the apparatus, the apparatus includes a roll having a plurality of color-code devices, wherein the plurality of color-code devices includes the first color-code device and a second color-code device, and wherein the second color-code device is separable from the first color-code device along a perforation line.

In some embodiments of the apparatus, the first piece of tape includes printed indicia.

In some embodiments of the apparatus, the release liner is wider than the first piece of tape such that the release liner extends away from the first piece of tape on both sides of the first piece of tape, and wherein the release liner includes a perforation line configured to permit removal of a first portion of the release liner proximate to the start end of the first piece of tape while a second portion of the release liner remains in place.

In some embodiments of the apparatus, the release liner includes a first release-liner portion having a first center-end tab and a second release-liner portion having a second center-end tab, wherein each center end tab extends from a center fold line in a direction away from the first piece of tape, and wherein the first center-end tab is longer than the second center-end tab.

In some embodiments of the apparatus, a length of a circumferential edge (e.g., 116 or 516) of the tape opposite the diagonal edge (e.g., 112 or 512) of the finish end of the first piece of tape has a length that is at least sixty-percent (60%) of a circumference of the cable.

In some embodiments of the apparatus, the start end of the first piece of tape has a diagonal edge at an acute angle to a lengthwise edge of the first piece of tape, and wherein the acute angle of the diagonal edge of the start end of the first piece of tape is substantially parallel to the acute angle of the diagonal edge of the finish end of the first piece of tape.

In some embodiments of the apparatus, the release liner is wider than the first piece of tape such that the release liner extends away from the first piece of tape on both sides of the first piece of tape, wherein the start end of the first piece of tape has a diagonal edge at an acute angle to a lengthwise edge of the first piece of tape, and wherein the acute angle of the diagonal edge of the start end of the first piece of tape is substantially parallel to the acute angle of the diagonal edge of the finish end of the first piece of tape.

In some embodiments, the present invention provides a method for color-coding a communications cable. This method includes: providing a first color-code device that includes a first pre-cut piece of tape having an adhesive surface covered by a release liner, wherein the first pre-cut piece of tape has a start end and a finish end, and wherein the finish end has a diagonal edge at an acute angle relative to a lengthwise edge of the first piece of tape; removing a first portion of the release liner of the first piece of tape; and beginning with the start end of the first piece of tape, wrapping the first piece of tape around the communications cable while removing a remaining portion of the release liner.

In some embodiments of the method, the providing of the first color-code device includes providing a roll having a plurality of color-code devices that includes the first color-code device and a second color-code device, the second color-code device includes a second pre-cut piece of tape having an adhesive surface covered by a release liner, the second pre-cut piece of tape has a start end and a finish end, and the finish end of the second piece of tape has a diagonal edge at an acute angle to a lengthwise edge of the second piece of tape, and the method further includes: separating the first color-code device from the second color-code device along a perforation line; and beginning with the start end of the second piece of tape, wrapping the second piece of tape around the communications cable while removing a remaining portion of the release liner of the second piece of tape.

In some embodiments of the method, the release liner of the first piece of tape includes at least one sideways-extending tab.

In some embodiments of the method, the release liner of the first piece of tape includes a first release-liner portion having a first center-end tab and a second release-liner portion having a second center-end tab, and wherein each center-end tab extends from a center-fold line in a direction away from the first piece of tape, and wherein the removing of the first portion of the release liner of the first piece of tape includes pulling the first portion of the release liner off of the first piece of tape using the first center-end tab.

In some embodiments of the method, the providing a first color-code device includes forming the diagonal edge of the finish end of the first piece of tape such that a length of a circumferential edge (e.g., 116 or 516) of the tape opposite the diagonal edge (e.g., 112 or 512) of the finish end of the first piece of tape has a length that is at least sixty-percent (60%) of a circumference of the communications cable.

In some embodiments of the method, the release liner of the first piece of tape is wider than the first piece of tape, wherein the first piece of tape is aligned closer to a first side of the release liner such that the release liner extends away from the first piece of tape to a second opposite side, and wherein the wrapping of the first piece of tape around the communications cable includes spacing the first piece of tape from a second piece of tape using the release liner.

In some embodiments of the method, the release liner is wider than the first piece of tape such that the release liner extends away from the first piece of tape on both sides of the first piece of tape to form side sections of the release liner, wherein the removing of the first portion of the release liner of the first piece of tape includes pulling the first portion of the release liner away from the first piece of tape using the side sections of the release liner.

In some embodiments, the present invention provides a method for forming a tape roll for flagging a communications cable, wherein the method includes: providing a tape having a pressure-sensitive adhesive surface; affixing a release liner to the adhesive surface of the tape to form a color-code tape system, wherein the release liner is wider than the tape such that the release liner extends away from the tape on both sides of the tape; and separating the color-code tape system into a plurality of color-code devices including a first color-code device and a second color-code device. In some embodiments, the separating includes: forming a first perforation line through the tape and the release liner, wherein the first perforation line separates the first color-coded device from the second color-code device at an acute angle relative to a lengthwise edge of the tape, and forming a second perforation line through the release liner at a start end of the release liner contained within the first color-code device.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

What is claimed is:

1. An apparatus for color-coding cable, the apparatus comprising:
a first color-code device having a first pre-cut piece of tape having an adhesive surface covered by a release liner, wherein the first pre-cut piece of tape has a start end and a finish end, and wherein the finish end has a diagonal edge at an acute angle relative to a lengthwise edge of the first piece of tape.

2. The apparatus of claim 1, wherein the apparatus includes a roll having a plurality of color-code devices, and wherein the plurality of color-code devices includes the first color-code device.

3. The apparatus of claim 1, further comprising at least one sideways-extending tab on the release liner.

4. The apparatus of claim 1, wherein the release liner includes a first release-liner portion having a first center-end tab and a second release-liner portion having a second center-end tab, and wherein each center-end tab extends from a center-fold line in a direction away from the first piece of tape.

5. The apparatus of claim 1, wherein the release liner is wider than the first piece of tape, and wherein the first piece of tape is aligned closer to a first side of the release liner such that the release liner extends away from the first piece of tape to a second opposite side in order to provide a spacing distance guide for installation of a plurality of such pieces of tape.

6. The apparatus of claim 1, wherein the apparatus includes a roll having a plurality of color-code devices, wherein the plurality of color-code devices includes the first color-code device and a second color-code device, and wherein the second color-code device is separable from the first color-code device along a perforation line.

7. The apparatus of claim 1, wherein the first piece of tape includes printed indicia.

8. The apparatus of claim 1, wherein the release liner is wider than the first piece of tape such that the release liner extends away from the first piece of tape on both sides of the first piece of tape, and wherein the release liner includes a perforation line configured to permit removal of a first portion of the release liner proximate to the start end of the first piece of tape while a second portion of the release liner remains in place.

9. The apparatus of claim 1, wherein the release liner includes a first release-liner portion having a first center-end tab and a second release-liner portion having a second center-end tab, wherein each center end tab extends from a center fold line in a direction away from the first piece of tape, and wherein the first center-end tab is longer than the second center-end tab.

10. The apparatus of claim 1, wherein the diagonal edge of the finish end of the first piece of tape has a length that is at least sixty-percent (60%) of a circumference of the cable.

11. The apparatus of claim 1, wherein the start end of the first piece of tape has a diagonal edge at an acute angle to a lengthwise edge of the first piece of tape, and wherein the acute angle of the diagonal edge of the start end of the first piece of tape is substantially parallel to the acute angle of the diagonal edge of the finish end of the first piece of tape.

12. The apparatus of claim 1, wherein the release liner is wider than the first piece of tape such that the release liner extends away from the first piece of tape on both sides of the first piece of tape, wherein the start end of the first piece of tape has a diagonal edge at an acute angle to a lengthwise edge of the first piece of tape, and wherein the acute angle of the diagonal edge of the start end of the first piece of tape is substantially parallel to the acute angle of the diagonal edge of the finish end of the first piece of tape.

13. A method for color-coding a communications cable, the method comprising:
providing a first color-code device that includes a first pre-cut piece of tape having an adhesive surface covered by a release liner, wherein the first pre-cut piece of tape has a start end and a finish end, and wherein the finish end has a diagonal edge at an acute angle relative to a lengthwise edge of the first piece of tape;
removing a first portion of the release liner of the first piece of tape; and
beginning with the start end of the first piece of tape, wrapping the first piece of tape around the communications cable while removing a remaining portion of the release liner.

14. The method of claim 13, wherein the providing of the first color-code device includes providing a roll having a plurality of color-code devices that includes the first color-code device and a second color-code device, wherein the second color-code device includes a second pre-cut piece of tape having an adhesive surface covered by a release liner, wherein the second pre-cut piece of tape has a start end and a finish end, and wherein the finish end of the second piece of tape has a diagonal edge at an acute angle to a lengthwise edge of the second piece of tape, the method further comprising:
separating the first color-code device from the second color-code device along a perforation line; and
beginning with the start end of the second piece of tape, wrapping the second piece of tape around the communications cable while removing a remaining portion of the release liner of the second piece of tape.

15. The method of claim 13, wherein the release liner of the first piece of tape includes at least one sideways-extending tab.

16. The method of claim 13, wherein the release liner of the first piece of tape includes a first release-liner portion having a first center-end tab and a second release-liner portion having a second center-end tab, and wherein each center-end tab extends from a center-fold line in a direction away from the first piece of tape, and wherein the removing of the first portion of the release liner of the first piece of tape includes pulling the first portion of the release liner off of the first piece of tape using the first center-end tab.

17. The method of claim 13, wherein the providing a first color-code device includes forming the diagonal edge of the finish end of the first piece of tape such that a length of an edge of the tape opposite the diagonal edge is at least sixty-percent (60%) of a circumference of the communications cable.

18. The method of claim 13, wherein the release liner of the first piece of tape is wider than the first piece of tape, wherein the first piece of tape is aligned closer to a first side of the release liner such that the release liner extends away from the first piece of tape to a second opposite side, and wherein the wrapping of the first piece of tape around the communications cable includes spacing the first piece of tape from a second piece of tape using the release liner.

19. The method of claim 13, wherein the release liner is wider than the first piece of tape such that the release liner extends away from the first piece of tape on both sides of the first piece of tape to form side sections of the release liner, wherein the removing of the first portion of the release liner of the first piece of tape includes pulling the first portion of the release liner away from the first piece of tape using the side sections of the release liner.

20. A method for forming a tape roll for flagging a communications cable, the method comprising:
providing a tape having an adhesive surface;
affixing a release liner to the adhesive surface of the tape to form a color-code tape system, wherein the release liner is wider than the tape such that the release liner extends away from the tape on both sides of the tape; and
separating the color-code tape system into a plurality of color-code devices including a first color-code device and a second color-code device, wherein the separating includes:
forming a first perforation line through the tape and the release liner, wherein the first perforation line separates the first color-coded device from the second color-code device at an acute angle relative to a lengthwise edge of the tape, and
forming a second perforation line through the release liner at a start end of the release liner contained within the first color-code device.
